(19) United States
(12) Patent Application Publication
(10) Pub. No.: US 2023/0008856 A1
(43) Pub. Date: Jan. 12, 2023

(54) NEURAL NETWORK FACILITATING FIXED-POINT EMULATION OF FLOATING-POINT COMPUTATION

(71) Applicants: Gregory Henry, Hillsboro, OR (US); Kermin Chofleming, Hudson, MA (US); Simon Steely, JR., Hudson, NH (US)

(72) Inventors: Gregory Henry, Hillsboro, OR (US); Kermin Chofleming, Hudson, MA (US); Simon Steely, JR., Hudson, NH (US)

(21) Appl. No.: 17/929,749

(22) Filed: Sep. 5, 2022

(51) Int. Cl. G06F 7/487; G06F 7/485; G06F 7/544; G06F 5/01; G06F 9/50

(52) U.S. Cl. CPC G06F 7/4876; G06F 7/485; G06F 7/5443; G06F 5/012; G06F 9/5027

(57) ABSTRACT

An DNN accelerator can perform fixed-point emulation of floating-point computation. In a multiplication operation on two floating-point matrices, the DNN accelerator determines an extreme exponent for a row in the first floating-point matrix and determines another extreme exponent for a column in the second floating-point matrix. The row and column can be converted to fixed-point vectors based on the extreme exponents. The two fixed-point vectors are fed into a PE array in the DNN accelerator. The PE array performs a multiplication operation on the two fixed-point vectors and generates a fixed-point inner product. The fixed-point inner product can be converted back to a floating-point inner product based on the extreme exponents. The floating-point inner product is an element in the matrix resulted from the multiplication operation on the two floating-point matrices. The matrix can be accumulated with another matrix resulted from a fixed-point emulation of a floating-point matrix multiplication.

### TECHNICAL FIELD

This disclosure relates generally to neural networks, and more specifically, to deep neural networks (DNN) that can facilitate fixed-point emulation of floating-point computation.

### BACKGROUND

DNNs are used extensively for a variety of artificial intelligence applications ranging from computer vision to speech recognition and natural language processing due to their ability to achieve high accuracy. However, the high accuracy comes at the expense of significant energy cost. DNNs have extremely high computing demands as each inference can require hundreds of millions of tensor operations, such as convolution, pooling operation, elementwise operations, and other types of tensor operations. Many tensor operations include matrix computation, such as matrix multiplication, matrix accumulation, etc. Therefore, techniques to improve efficiency of matrix computation for deep learning are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 is a block diagram of an example DNN accelerator, in accordance with various embodiments.

FIG. 3 illustrates a process of fixed-point emulation of a floating-point multiplication operation, in accordance with various embodiments.

FIG. 4 illustrates a conventional floating-point matrix multiplication, in accordance with various embodiments.

FIG. 5 illustrates an exponent extraction module, in accordance with various embodiments.

FIG. 6 illustrates another exponent extraction module, in accordance with various embodiments.

FIG. 7 illustrates a conversion module, in accordance with various embodiments.

FIG. 8 illustrates an inverse transformation module 800, in accordance with various embodiments.

FIG. 9 illustrates a PE array, in accordance with various embodiments.

FIG. 10 is a block diagram of a PE, in accordance with various embodiments.

FIG. 11 is a flowchart showing a method of deep learning, in accordance with various embodiments.

FIG. 12 illustrates a deep learning environment, in accordance with various embodiments.

FIG. 13 is a block diagram of an example DNN system, in accordance with various embodiments.

FIG. 14 is a block diagram of an example computing device, in accordance with various embodiments.

### DETAILED DESCRIPTION

### Overview

DNNs are widely used in the domains of computer vision, speech recognition, image, and video processing mainly due to their ability to achieve beyond human-level accuracy. Many training and inference operations of DNNs involve floating-point computation. A significant amount of computational overhead of these operations is in matrix multiplication. Many computer architectures (e.g., CPU, GPU, FPGA, custom, Al (artificial intelligence)-specific accelerators, etc.) have adopted hardware accelerators in the form of systolic arrays for matrix multiplication. Present arrays can support various data types, such as fixed point and floating point, in the array itself. However, such arrays have disadvantages including hardware complexity, inefficiency in runtime power, and limited performance.

To address these disadvantages, many currently available arrays have adopted native, in-array support for floating point computation. Attempts have been made to use hardware developed for integer multiplication to perform block floating-point multiplication. However, such hardware floating-point support is expensive and power intensive. For example, current matrix multiplication arrays offer twice the integer throughput as floating-point throughput. Using integer computation to emulate floating point can unlock this higher performance. Therefore, improved technology for floating-point matrix multiplication is needed.

Embodiments of the present disclosure may improve on at least some of the challenges and issues described above by providing an DNN accelerator that enables the emulation of floating-point computation using fixed-point arithmetic. An example DNN accelerator can perform fixed-point emulation of multiplication operations on floating-point matrixes without significant or any change to a systolic array designed for fixed-point/integer tensor computation.

For a multiplication operation on a first floating-point matrix and a second floating-point matrix, the DNN accelerator can determine extreme exponents for each row in the first floating-point matrix and each column in the second floating-point matrix. A row or column in a floating-point matrix may be referred to as a floating-point vector. A floating-point vector includes a sequence of floating-point values. Each floating-point value may be in a floating-point format, such as FP32, FP16, BF16, and so on. A floating-point vector may include a sign, an exponent, and a mantissa, each of which can have one or more bits. In an example, the DNN accelerator extracts the highest exponent from the exponents of all the floating-point values in a floating-point vector as the extreme exponent of the floating-point vector. The DNN accelerator can further convert the floating-point vector into a fixed-point vector based on the extreme exponent, e.g., by shifting bits in the mantissa of each floating-point value in the floating-point vector based on the extreme exponent and the exponent of the floating-point value. The extraction of the extreme exponent and conversion of the floating-point vector can be done by digital circuits. A digital circuit is a circuit that can process digital signals. A digital circuit may include one or more digital electronic components. A digital circuit may include a logic circuit, e.g., arithmetic logic unit (ALU) or other types of logic circuit. The digital circuits in the DNN accelerator can be arranged outside the PE array so that minimum or no change to the PE array is needed to perform the fixed-point emulation of the floating-point matrix multiplication.

After the conversion of the floating-point vector to the fixed-point vector, the DNN accelerator can feed a pair of fixed-point vectors (e.g., one converted from a row in the first floating-point matrix and the other one converted from a column in the second floating-point matrix) into a PE array. The PE array performs a multiplication operation on the two fixed-point vectors and determines a fixed-point inner product. The DNN accelerator can convert the fixed-point inner product to a scaled floating-point inner product based on the extreme exponents corresponding to the two fixed-point vectors. The conversion of the fixed-point inner product can be done by one or more additional digital circuits that are also arranged outside the PE. The scaled floating-point inner product may be an element in a floating-point matrix that is the result of the fixed-point emulation of the multiplication operation on the first floating-point matrix and the second floating-point matrix. The floating-point matrix can be accumulated with another floating-point matrix resulted from a fixed-point emulation of a floating-point matrix multiplication or some other computation.

Compared with DNN accelerators performing conventional floating-point computation, the DNN accelerator in the present disclosure, which performs fixed-point emulation of conventional floating-point computation by converting floating-point to fixed-point, can have better performance. Moreover, operating in fixed-point can improve the accuracy of the matrix multiplications. This can enable some Al operations to use lower precision types or realize improved performance through reduced iterations-to-convergence. The present disclosure can also allow removal of some or all direct floating-point support from systolic array hardware which would result in substantial area and power savings.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

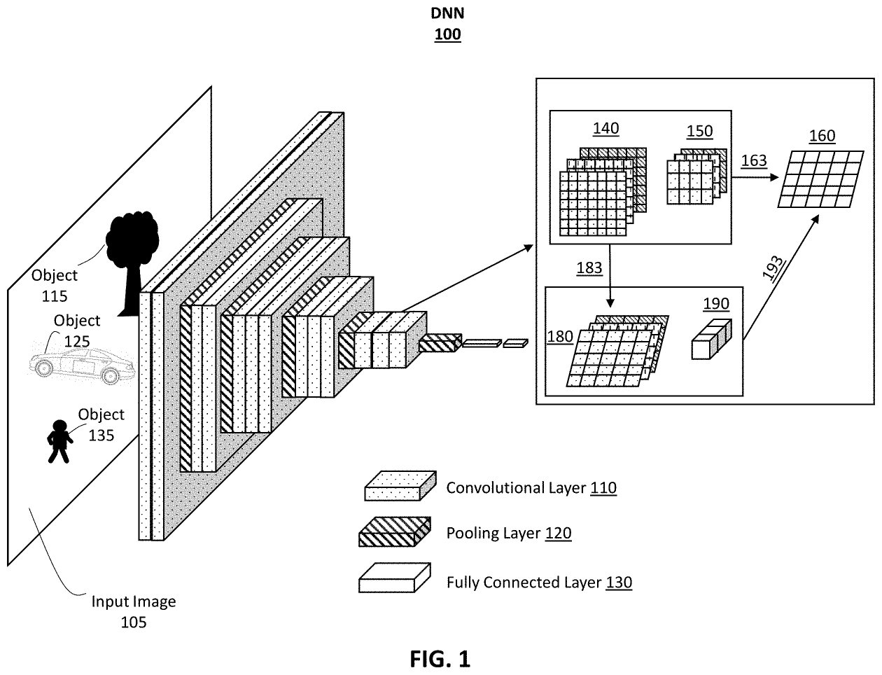

FIG. 1 illustrates an example DNN 100, in accordance with various embodiments. For purpose of illustration, the DNN 100 in FIG. 1 is a convolutional neural network (CNN). In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as input feature map (IFM) 140) and a filter 150. As shown in FIG. 1, the IFM 140 is represented by a 7×7×3 three-dimensional (3D) matrix. The IFM 140 includes three input channels, each of which is represented by a 7×7 two-dimensional (2D) array. The 7×7 2D array includes 7 input elements (also referred to as input points) in each row and 7 input elements in each column. The filter 150 is represented by a 3×3×3 3D matrix. The filter 150 includes three kernels, each of which may correspond to a different input channel of the IFM 140. A kernel a 2D array of weights, where the weights are arranged in columns and rows. A kernel can be smaller than the IFM. In the embodiments of FIG. 1, each kernel is represented by a 3×3 2D array. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D array. The 5×5 2D array includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D array of output elements. As such, the 2D output array (i.e., the OFM 160) from the standard convolution 163 is referred to an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes three output channels, each of which is represented by a 5×5 2D array. The 5×5 2D array includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has four hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns an operand of size N, where N is the number of classes in the image classification problem. In the embodiments of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

### Example DNN Accelerator

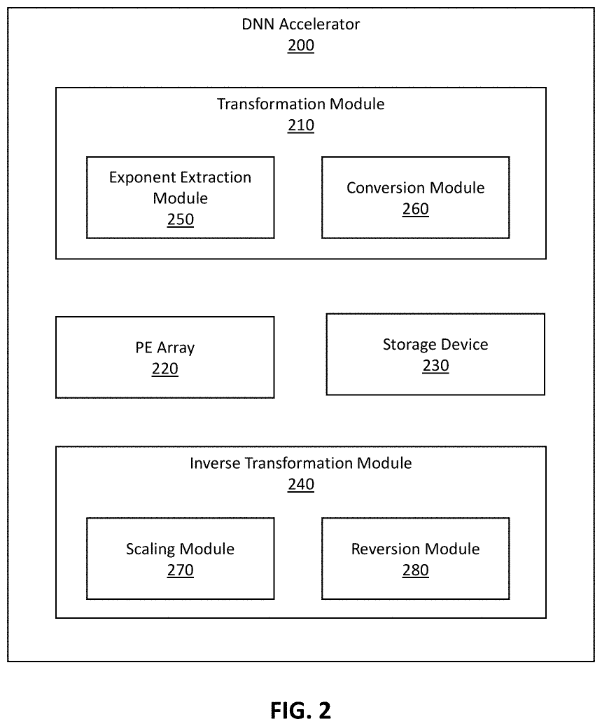

FIG. 2 is a block diagram of an example DNN accelerator 200, in accordance with various embodiments. The DNN accelerator 200 can perform tensor operations in some or all layers of a DNN, such as the DNN 100 in FIG. 1. Tensor operations may include convolution, pooling operation, elementwise operation (e.g., elementwise addition, elementwise multiplication, etc.), loading, reducing, other types of tensor operations by the DNN, or some combination thereof. Many tensor operations include floating-point matrix multiplication. The DNN accelerator 200 can receive floating-point matrices as inputs and perform various matrix operations on the floating-point matrices. In the embodiments of FIG. 2, the DNN accelerator 200 includes a transformation module 210, a PE array 220, a storage device 230, and an inverse transformation module 240. In some embodiments, the transformation module 210 or inverse transformation module 240 may be implemented at least partially in hardware. For instance, the transformation module 210 or inverse transformation module 240 may include one or more digital or analog circuits that perform some or all of the functions described below. In other embodiments, alternative configurations, different or additional components may be included in the DNN accelerator 200. For instance, the DNN accelerator 200 may include multiple storage devices or multiple PE arrays. Further, functionality attributed to a component of the DNN accelerator 200 may be accomplished by a different component included in the DNN accelerator 200 or by a different system. For instance, a part of or the whole storage device 230 may be included in the PE array 220.

The transformation module 210 transforms floating-point matrices to fixed-point matrices. A floating-point matrix is a matrix including at least one floating-point number. Floating-point numbers may be in various floating-point formats, such as FP16, BF16, and so on. Floating-point numbers can be packed into a computer datum as the sign bit, the exponent field, and the mantissa or significand, from left to right. The sign bit of a floating-point number defines whether the floating-point number is positive or negative. In some embodiment, a sign bit of 1 represents that the floating-point number is a negative number, versus a sign bit of 0 represents that the floating-point number is a positive number. The exponent field represents the power of 2. The mantissa represents the actual binary digits of the floating-point number. The mantissa may be the part of the floating-point number that represents the significant digits of that number, and that is multiplied by the base raised to the exponent to give the actual value of the number. The floating-point number may be represented by a sequence of bits. For instance, a FP16 number may be represented by 16 bits, including a bit representing sign, five bits representing exponent, and ten bits representing mantissa. A BF16 operand may include a bit representing sign, eight bits representing exponent, and seven bits representing mantissa.

The transformation module 210 can transform all floating-point numbers in a floating-point matrix to fixed-point numbers and obtain a fixed-point matrix corresponding to the floating-point matrix. Fixed-point can represent a fractional number by storing a fixed number of digits of the fractional part of the number. A fixed-point number has a specific number of digits reserved for the integer part and fractional part. In contrast, a floating-point number does not have a specific number of digits reserved for the integer part or the fractional part. In an example fixed-point representation, the fraction is expressed in the same number base as the integer part, but using negative powers of the base b. A fixed-point representation can be binary (base 2), which is also known as binary scaling. In embodiments where n fraction digits are stored, the value of the fixed-point number equal an integer multiple of b⁻ⁿ.

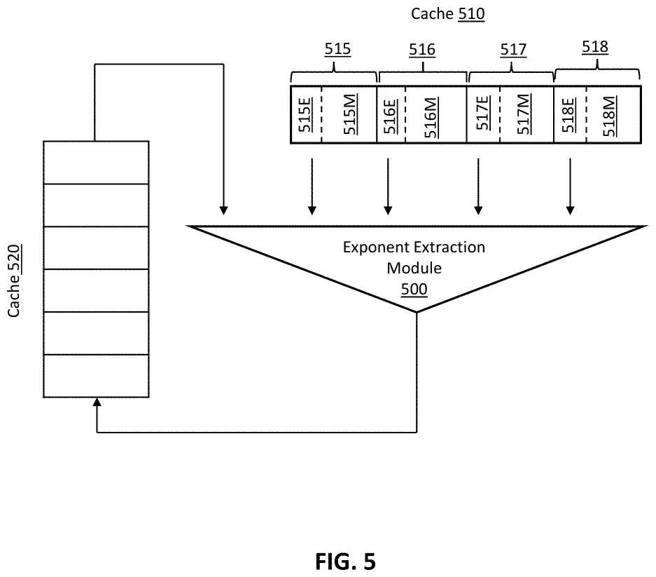

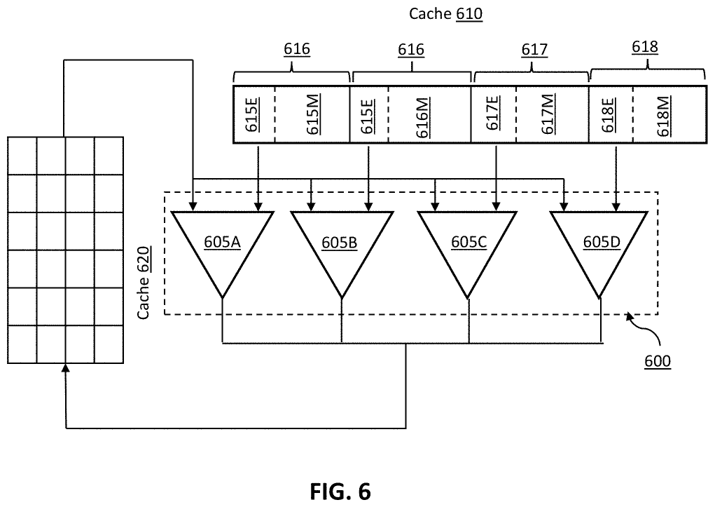

In some embodiments, the transformation module 210 transforms floating-point matrices to fixed-point matrices based on exponent extraction. In FIG. 2, the transformation module 210 includes an exponent extraction module 250 and a conversion module 260. The exponent extraction module 250 determines extreme exponents in floating-point matrices. In an embodiment where a first floating-point matrix is to be multiplied with a second floating-point matrix, the exponent extraction module 250 determines an extreme exponent for each row of the first floating-point matrix. The extreme exponent is the exponent having the largest value among all the exponents of all the numbers in the row. For a floating-point matrix having X rows, the exponent extraction module 250 extracts X extreme exponents. The exponent extraction module 250 also determines an extreme exponent for each column of the second floating-point matrix. The extreme exponent is the exponent having the largest value among all the exponents of all the numbers in the column. For a floating-point matrix having Y rows, the exponent extraction module 250 extracts Y extreme exponents. Extreme exponents determined by the exponent extraction module 250 can be stored in the storage device 230. In some embodiments, extreme exponents are stored as metadata of the corresponding floating-point matrix. The metadata may also include information identifying the floating-point matrix for further processing of the floating-point matrix with the extreme exponents, e.g., by the conversion module 260. More details regarding the exponent extraction module 250 are described below in conjunction with FIGS. 5 and 6.

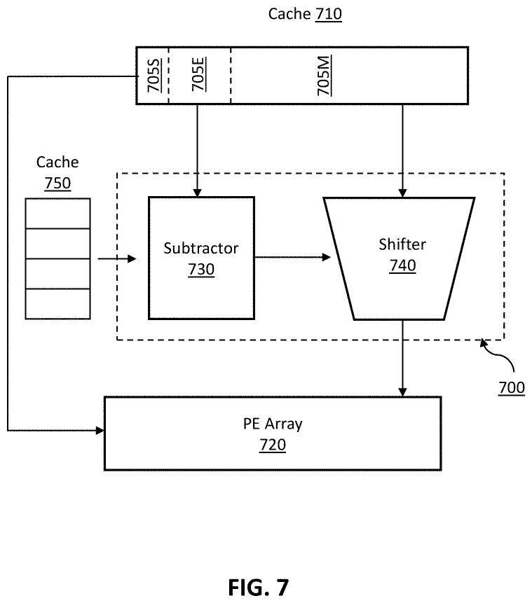

The conversion module 260 converts floating-point matrices to fixed-point matrices based on extreme exponents from the exponent extraction module 250. The conversion module 260 can convert floating-point numbers in each row or column of a floating-point matrix to fixed-point numbers based on the extreme exponent of the row or column. To convert a floating-point number to a fixed-point number with an extreme exponent, the conversion module 260 determines a shifting factor based on the extreme exponent and the exponent of the floating-point number. The shifting factor may have a value equal to a difference between the extreme exponent and the exponent of the floating-point number. For instance, the shifting factor may equal a result of the extreme exponent subtracted by the exponent of the floating-point number. In an example where the extreme exponent is 5 and the exponent of the floating-point number is 0, the shifting factor is 5. Then the conversion module 260 shifts the bits in the mantissa of the floating-point number to the right based on the shifting factor. In an example where the mantissa is 1.000000000 and the shifting point is 5, the fixed-point number is 0.00001000. After the conversion module 260 finishes converting all the floating-point numbers in a floating-point matrix to fixed-point numbers, the conversion module 260 obtains a fixed-point matrix. More details regarding the conversion module 260 are described below in conjunction with FIG. 7. Fixed-point matrices generated by the conversion module 260 are stored in the storage device 230 and can be processed by the PE array 220.

The PE array 220 performs tensor computation, which includes matrix multiplication. For instance, the PE array 250 performs multiply-accumulate (MAC) operations, including fixed-point MAC operations. In some embodiments, the PE array 220 performs multiplication of fixed-point matrices. For instance, the PE array 220 may receive a first fixed-point matrix and a second fixed-point matrix from the conversion module 260. The PE array 220 performs a group of multiplication operations, each of which is a multiplication of a row of the first fixed-point matrix and a column of the second fixed-point matrix. Within each multiplication operation, the PE array 220 performs a group of sub-operations. A sub-operation is a multiplication of a first element in the row of the first fixed-point matrix and a second element in the column of the second fixed-point matrix. The row index of the first element may match (e.g., equal) the column index of the second element. The PE array 220 then accumulates the products of the sub-operations and obtain an individual fixed-point number, which is the result of the multiplication operation.

The result of the group of multiplication operations is a new fixed-point matrix, which can be stored in the storage device 230. The PE array 220 may also accumulate fixed-point matrices resulted from multiplication operations. For instance, the PE array 220 may perform an accumulation operation on two or more fixed-point matrices to obtain a sum of the fixed-point matrices. The sum of the fixed-point matrices is another new fixed-point matrix.

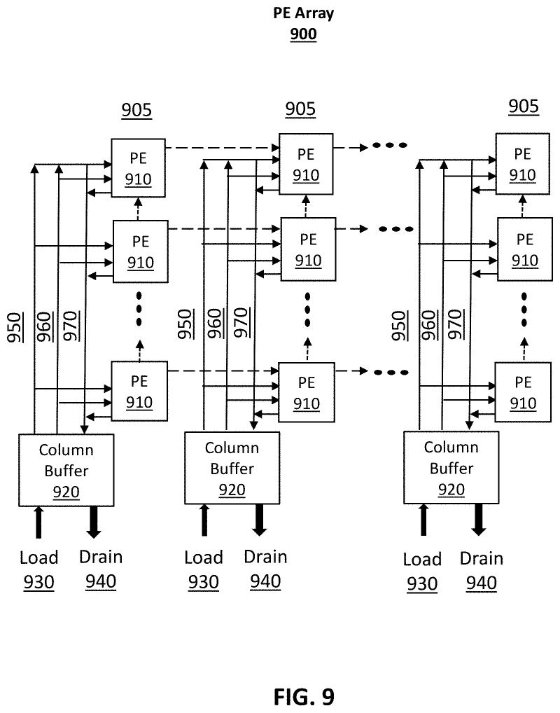

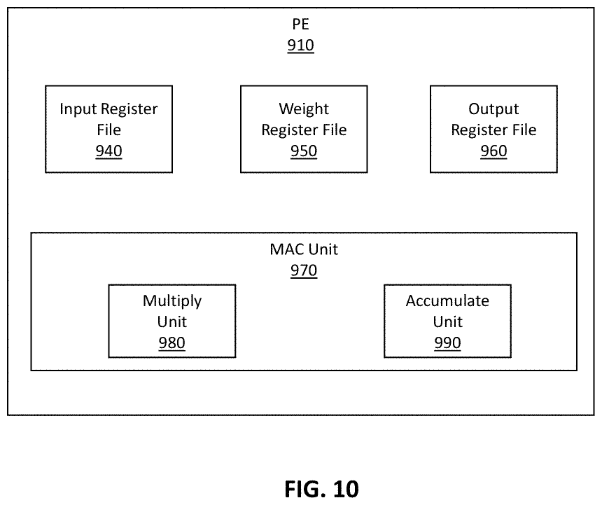

The PE array 220 may be a systolic array. In some embodiments, the PE array 220 is designed for performing computation of fixed-point matrices. The PE array 220 may include a plurality of PEs. The PEs may be arranged in columns and rows. A PE may also be referred to as a node. The PE array 250 may be a tile, or a portion of a tile, of a DNN layer having a tile architecture. The DNN layer may include one or more other PE arrays that may operate in parallel with the PE array 250. In some embodiments, the PE array 250 receive an IFM and filters of a DNN layer and generates the OFM of the layer through the MAC operations. The OFM may be used as an IFM of a subsequent layer. More details regarding the PE array 250 are described below in conjunction with FIGS. 9 and 10.

The storage device 230 stores data for the DNN accelerator 200, such as data received, used, generated, or otherwise associated with the DNN accelerator 200. For instance, the storage device 230 stores floating-point matrices, extreme exponents, metadata of floating-point matrices, fixed-point matrices, and so on. The storage device 230 may be local to the PE array 220. In some embodiment, at least a part of the storage device 230 may be implemented within the PE array, or even within individual PEs in the PE array. The storage device 230 may include memories at different levels, e.g., registers, cache memories of various levels (e.g., L0, L1, L2, L3, etc.), primary storage memory, and so on. In an example, the storage device 230 may include the cache 510, 520, 610, 620, or 750 described below in conjunction with FIGS. 5-7.

The inverse transformation module 240 transforms fixed-point matrices (e.g., fixed-point matrices output from the PE array 220) to floating-point matrices. The inverse transformation module 240 may transform all the fixed-point numbers in a fixed-point matrix to floating-point numbers based on the extreme exponents determined by the exponent extraction module 250. In FIG. 2, the inverse transformation module 240 includes a reversion module 280 and a scaling module 270.

In some embodiments, the scaling module 270 scales fixed-point numbers in fixed-point matrices output from the PE array 220 based on extreme exponents determined by the exponent extraction module 250. For a fixed-point number in a fixed-point matrix that is a result of a multiplication of a row in a first fixed-point matrix and a column in a second fixed-point matrix, the scaling module 270 may determine a scaling factor based on the extreme exponents of the row and column. In some embodiments, the scaling factor is a product of multiplying the extreme exponent of the row by the extreme exponent of the column. Then the scaling module 270 shifts the bits in the fixed-point number to the left based on the scaling factor, e.g., by the value of the scaling factor. In an example where the fixed-point number is 0.100001101000000 and the shifting point is 5, the fixed-point number is 100001101.00000000000000. After the scaling module 270 finishes scaling all the fixed-point numbers in the fixed-point matrix, the scaling module 270 obtains a scaled fixed-point matrix, which can be stored in the storage device 230 and be further processed by the reversion module 280.

The reversion module 280 converts fixed-point matrices from the scaling module 270 to floating-point matrices. The reversion module 280 may convert all the fixed-point number in a fixed-point matrix to floating-pointed number and generate a floating-point matrix. In some embodiments, for a fixed-point number the reversion module 280 generates exponents bits and mantissa bits based on a floating-point format to obtain the corresponding floating-point number. The floating-point matrix is considered as the float-point result of the multiplication of the two initial floating-point matrices. After a fixed-point matrix is converted to a floating-point matrix, the floating-point matrix can be stored in the storage device 230. In some embodiments, the floating-point matrix may be fed to the PE array 220 or a different PE array 220 for further processing. In an example, the floating-point matrix may be accumulated with one or more other floating-point matrices to obtain a partial sum matrix.

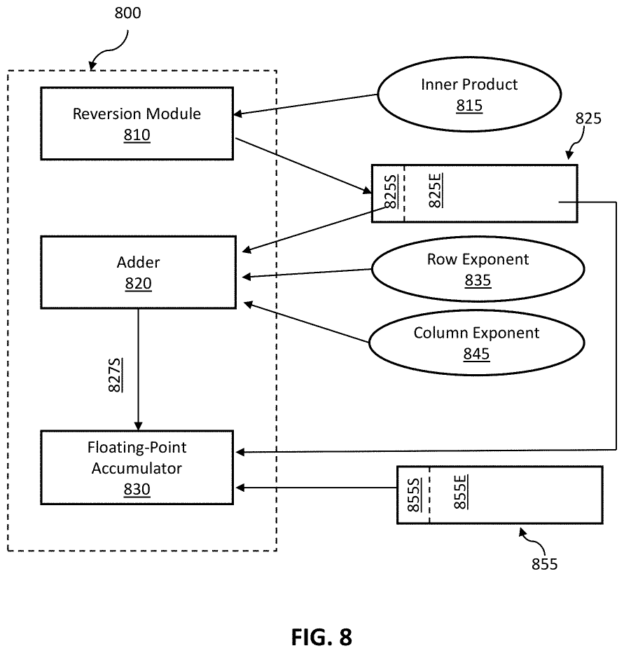

In other embodiments, the reversion module 280 may convert fixed-point numbers in fixed-point matrices output from the PE array 220 to floating-point numbers. Then the scaling module 270 scales the floating-point numbers. More details regarding the inverse transformation module 240 are described below in conjunction with FIG. 8.

### Example Fixed-point Emulation of Floating-point Multiplication

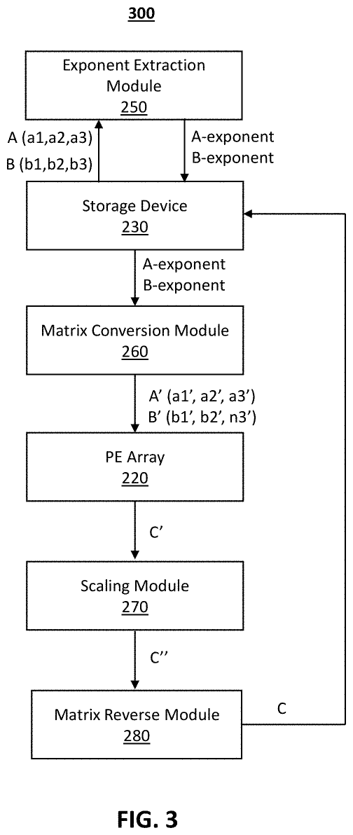

FIG. 3 illustrates a process 300 of fixed-point emulation of a floating-point multiplication operation, in accordance with various embodiments. The process 300 can be performed by the DNN accelerator 200 in FIG. 2. For purpose of simplicity and illustration, the process 300 includes a multiplication of a floating-point vector A and another floating-point vector B. The vector A is a row of a first floating-point matrix and includes three elements a1, a2, and a3, each of which is a floating-point number. The vector B is a column of a second floating-point matrix includes three elements b1, b2, and b3, each of which is a floating-point number. In other embodiments, the vector A or B may include a different number of elements. Also, the first floating-point matrix may include additional rows. The second floating-point matrix may include additional columns.

The floating-point vectors A and B are stored in the storage device 230. The exponent extraction module 250 can retrieve the vectors A and B from the storage device 230. The exponent extraction module 250 determines an extreme exponent A-exponent for the vector A, e.g., by identifying the exponents of the elements a1, a2, and a3 and selecting the largest exponent from the three exponents as the extreme exponent A-exponent. Similarly, the exponent extraction module 250 determines an extreme exponent B-exponent for the vector B, e.g., by identifying the exponents of the elements b1, b2, and b3 and selecting the largest exponent from the three exponents as the extreme exponent B-exponent. The exponent extraction module 250 stores the two extreme exponents A-exponent and B-exponent in the storage device 230.

Next, the conversion module 260 retrieves the two extreme exponents A-exponent and B-exponent from the storage device. In other embodiments, the conversion module 260 may receive the two extreme exponents A-exponent and B-exponent from the exponent extraction module 250. The conversion module 260 converts the vector A to a fixed-point vector A′ that includes three fixed-point elements a1′, a2′, and a3′. The conversion module 260 determines a1′ based on the mantissa of al and the extreme exponent A-exponent. For instance, the conversion module 260 determines a shifting factor for a1 by subtracting the extreme exponent from the exponent of a1. The shifting factor is the number of positions that the conversion module 260 moves the bits in the mantissa of a1 to the right to generate a1′.

Similarly, the conversion module 260 determines a shifting factor for a2 by subtracting the extreme exponent from the exponent of a2 and moves the bits in the mantissa of a2 to the right based on the shifting factor to generate a2′. Also, the conversion module 260 generates a3′ by determining a shifting factor for a3 by subtracting the extreme exponent from the exponent of a3 and moves the bits in the mantissa of a3 to the right based on the shifting factor. Then the conversion module 260 can output the fixed-point vector A′. The conversion module 260 performs similar conversions on the vector B and outputs the fixed-point vector B′ that includes three fixed-point elements b1′, b2′, and b3′. Even though not shown in FIG. 3, the fixed-point vectors A′ and B′ can be stored in the storage device 230.

The PE array 220 receives the fixed-point vector A′ and B′ as inputs and performs a multiplication on the two vectors. The result of the multiplication is C′, which equals a1′×b1′+a2′×b2′+a3′×b3′. C′ is a fixed-point number and may be stored in the storage device 230. In some embodiments, the PE array 220 includes an analog circuit and processes analog signals. In other implementations, a digital circuits and processes may be used. In embodiments where the fixed-point vectors A′ and B′ are digital signals, the PE array 220 may include one or more digital-to-analog converters to convert the digital signals to analog signals before the multiplication operation is performed.

The fixed-point number C′ is provided to the scaling module 270, which scales C′ based on A-exponent and B-exponent and generates a new fixed-point number C″. In some embodiments, the scaling module 270 determines a scaling factor, which equals A-exponent x B-exponent. The scaling factor is the number of positions that the scaling module 270 moves the bits in C′ to the left to generate C″. C″ may be stored in the storage device 230. The reversion module 280 receives the fixed-point number C″ as an input and converts the fixed-point number C″ to a floating-point number C. In some embodiments, the reversion module 280 converts C″ to C based on a floating-point format, such as FP16, BF16, and so on. These operations may be reordered to reduce hardware complexity. The reversion module 280 may determine the sign, exponent, and mantissa of C. The reversion module 280 determine the numbers of bits for the sign, exponent, and mantissa based on the floating-point format. C is stored in the storage device 230 and may be processed further by the PE array 220 or a different PE array.

The process 300 is a low-precision approach of multiplying floating-point matrices on fixed-point arithmetic. The approach includes converting floating-point numbers to fixed-point numbers in hardware, conducting the matrix multiplication in fixed point, and then converting back to floating point. The approach requires minimal or no change to the PE array 220, which may be designed for fixed-point computation. The input and output of the DNN accelerator 200 are still floating-point matrices. Also, the DNN accelerator 200 can perform larger matrix operations composed of smaller matrix operations. For instance, a matrix can be divided into multiple smaller matrices, which are used for smaller matrix operations. After the smaller matrix operations are conducted, the DNN accelerator 200 can combine the results of the smaller matrix operations. Moreover, as shown in FIG. 3, the exponent extraction module 250, conversion module 260, scaling module 270, and reversion module 280 are outside the PE array 220 and does not interfere with any of the computation done by the PE array 220. Such hardware modifications can be constrained to the perimeter of the PE array 220, rather than the array internals. Also, this approach can allow the removal of some or all direct floating-point support from systolic array hardware which would result in substantial area and power savings without significant sacrifice of the precision of the multiplication result.

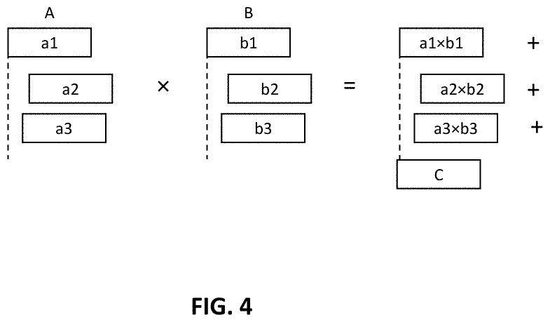

FIG. 4 illustrates a conventional floating-point matrix multiplication, in accordance with various embodiments. For purpose of simplicity and illustration, FIG. 4 shows the conventional multiplication of a floating-point vector A including elements a1, a2, and a3 and another floating-point vector B including elements b1, b2, and b. The vector A may be a row of a first floating-point matrix, the vector B may be a column of a second floating-point matrix. The vectors A and B may be examples of the floating-point vectors A and B, respectively in FIG. 3. The exponents of a1, a2, and a3 are shown normalized to the exponent of the highest magnitude element in the vector A, which is the a1. The exponents of b1, b2, and b3 are shown normalized to the exponent of the highest magnitude element in the vector B, which is the b1. The exponent in the highest magnitude element in a vector is the extreme exponent of the vector.

The multiplication of the floating-point vectors A and B is a part of the multiplication of the two floating-point matrices. In the embodiments of FIG. 4, the element al has the highest exponent in the floating-point vector A. The element b1 has the highest exponent in the floating-point vector B. The product of the vectors A and B is an inner product C. FIG. 4 shows that the inner product is the sum of three product elements: a1×b1, a2×b2, and a3×b3. The exponents of the three product elements are shown normalized to the highest magnitude product element, i.e., a1×b1. Multiplication may change the magnitude of the inner product, but the product of the two highest magnitude elements of the vectors A and B (i.e., the product of a1 and b1, which is a1×b1) is larger than the other two inner products (i.e., a2×b2, and a3×b3).

This nature of floating-point matrix multiplication enables floating-point multiplication to be reframed as fixed-point multiplication. In a floating-point multiplication, shifting and rounding may happen at each multiplication. Using extreme exponents provides a way of estimating the exponent of the inner product, allowing each product element of the inner product to scaled to the estimated final exponent prior to any multiplication. This permits all multiplications and additions during the inner product calculation to occur in fixed point by using the extreme exponent. After the fixed-point inner product is determined, scaling can be performed on the inner product and the result of the scaling can be converted back in to floating point.

FIG. 5 illustrates an exponent extraction module 500, in accordance with various embodiments. The exponent extraction module 500 may be an embodiment of the exponent extraction module 250 in FIG. 2. The exponent extraction module 500 in FIG. 5 is implemented in hardware. The exponent extraction module 500 may include a digital circuit, such as a maximum selection logic, that can select the maximum number from two or more inputs. The exponent extraction module 500 can determine an extreme exponent of a row or a column (collectively referred to as a vector) of a matrix, e.g., a floating-point matrix. Determining the extreme requires the observation of all values in the vector. In the embodiments of FIG. 5, the values (515, 516, 517, and 518) of the vector are stored in a cache 510, where the four values may be line-oriented and can be packed in a cache line. For instance, the vector is a row for a row-major order data array. For a column-major order data array, the vector is a column. Each value is a floating-point number that includes an exponent and a mantissa. The value 515 includes an exponent 515E and a mantissa 515M. The value 516 includes an exponent 516E and a mantissa 516M. The value 517 includes an exponent 517E and a mantissa 517M. The value 518 includes an exponent 518E and a mantissa 518M. For purpose of simplicity and illustration, FIG. 5 does not show the sign bits of the values. In other embodiments, the vector may include a different number of values.

In some embodiments, the values of the vector are packed in a cache line and can be read from the memory into the cache 510 as one data package. The values may be written into the cache 510 from another memory, e.g., a primary memory. A primary memory may be a random-access memory. The cache 510 may be included in the storage device 230 in FIG. 2. The values can be fed into the exponent extraction module 500 from the cache 510 to minimize or even avoid latency of reading the values from the memory. The exponent extraction module 500 can select the extreme exponent from the incoming cache line. The cache line may include the exponents 515E, 516E, 517E, and 518E. In some embodiments, the cache line may also include the mantissas 515M, 516M, 517M, and 518M. The whole vector, i.e., all the four values, can be stored in a matrix store for further operation, e.g., for being converted to fixed-point values. The memory store may be a different storage unit in the cache 610 from the storage unit where the exponents 515E, 516E, 517E, and 518E are stored, another cache, or a different type of memory.

In the embodiments of FIG. 5, the extreme exponent of a vector is initially set to the minimum exponent for the floating-point format of the vector. The minimum extreme exponent is stored in another cache 520. The minimum extreme exponent is fed into the exponent extraction module 500 from the cache 520. Also, the exponent 515E of the value 515 is fed into the exponent extraction module 500 from the cache 520. The exponent extraction module 500 identifies the higher exponent from the minimum extreme exponent and the exponent 515E and transmits the higher exponent into the cache 520. In embodiments where the exponent 515E is higher than the minimum extreme exponent, the higher exponent may replace the minimum extreme exponent in the cache 520. For instance, the minimum extreme exponent may be removed, and the exponent 515E is stored. For purpose of illustration, the higher exponent is referred to as the first higher exponent. Next, the first higher exponent and the exponent 516E are fed into the exponent extraction module 500 from the caches 520 and 510, respectively. The exponent extraction module 500 then identifies the higher exponent (the second higher exponent) between the first higher exponent and the exponent 516. The second higher exponent may be the first higher exponent or the exponent 516. The second higher exponent is then written into the cache 520. This process is repeated across the vector until the entire vector has been scanned, at which point the extreme exponent for the vector has been discovered. The extreme exponent is stored in the cache 520 and may be used further in the multiplication operation, e.g., it can be used to convert the floating-point matrix into a fixed-point matrix and to scale the multiplication result. For the conversation and scaling, the extreme exponent can be read from the cache 520 to minimize or avoid latency of reading from a primary memory.

FIG. 6 illustrates another exponent extraction module 600, in accordance with various embodiments. The exponent extraction module 600 may be an embodiment of the exponent extraction module 250 in FIG. 2. The exponent extraction module 600 in FIG. 6 is implemented in hardware. The exponent extraction module 600 includes a series of four digital circuits 605A-605D (collectively referred to as “ALUs 605” or “ALU605”). A digital circuit 605 can select the maximum number of two or more inputs. A digital circuit 605 may be a maximum selection logic unit. The exponent extraction module 600 can determine an extreme exponent of a row or a column (collectively referred to as a vector) of a matrix, e.g., a floating-point matrix. Determining the extreme requires the observation of all values in the vector. In the embodiments of FIG. 6, the values (615, 616, 617, and 618) of the vector are stored a cache 610, where the four values may be non-cache line-oriented. The vector may be a row in a column-major order data array. For a row-major order data array, the vector is a column.

Each value is a floating-point number that includes an exponent and a mantissa. The value 615 includes an exponent 615E and a mantissa 615M. The value 616 includes an exponent 616E and a mantissa 616M. The value 617 includes an exponent 617E and a mantissa 617M. The value 618 includes an exponent 618E and a mantissa 618M. For purpose of simplicity and illustration, FIG. 6 does not show the sign bits of the values. In other embodiments, the vector may include a different number of values. The values may be written into the cache 610 from another memory, e.g., a primary memory. A primary memory may be a random-access memory. The cache 610 may be included in the storage device 230 in FIG. 2. The values can be fed into the exponent extraction module 600 from the cache 610 to minimize or even avoid latency of reading the values from the memory.

In an example where the values 615, 616, 617, and 618 are in a column of a row-major order data array, each word of the incoming cache line from the cache 610 is compared with prior maximum value for the appropriate column, which is stored in the cache 620. As shown in FIG. 6, the digital circuit 605A receives the exponent 615E from the cache 610 and receives the prior maximum value of the corresponding column from the cache 620. The digital circuit 605A selects the higher exponent (first higher exponent) between the exponent 615E and the prior maximum value. The first higher exponent is then stored in the cache 620. The digital circuit 605B receives the exponent 616E from the cache 610 and receives the prior maximum value of the corresponding column from the cache 620. The digital circuit 605B selects the higher exponent (second higher exponent) between the exponent 616E and the prior maximum value. The second higher exponent is then stored in the cache 620. The digital circuit 605C receives the exponent 617E from the cache 610 and receives the prior maximum value of the corresponding column from the cache 620. The digital circuit 605C selects the higher exponent (third higher exponent) between the exponent 617E and the prior maximum value. The third higher exponent is then stored in the cache 620. The digital circuit 605D receives the exponent 618E from the cache 610 and receives the prior maximum value of the corresponding column from the cache 620. The digital circuit 605D selects the higher exponent (fourth higher exponent) between the exponent 618E and the prior maximum value. The fourth higher exponent is then stored in the cache 620. Both row and column extreme exponents may be determined in parallel for a particular input matrix.

In some embodiments, the whole vector, i.e., all the four values, can be stored in a matrix store for further operation, e.g., for being converted to fixed-point values. The memory store may be a different storage unit in the cache 610 from the storage unit where the exponents 615E, 616E, 617E, and 618E are stored, another cache, or a different type of memory.

FIG. 7 illustrates a conversion module 700, in accordance with various embodiments. The conversion module 700 is an embodiment of the conversion module 260 in FIG. 2. The conversion module 700 is implemented in hardware. The conversion module 700 include a subtractor 730 and a shifter 740. The subtractor 730 or shifter 740 may be a digital circuit. In other embodiments, the conversion module 700 may include different component(s).

In FIG. 7, the conversion module 700 processes a floating-point number stored in a cache 710. The floating-point number includes a sign bit 705S, an exponent 705E, and a mantissa 705M. The sign bit 705S is transmitted to a PE array 720 for performing signed multiplication. The PE array 720 may be an embodiment of the PE array 220 in FIG. 2. The exponent 705E is transmitted to the subtractor 730. The subtractor 730 also receives an extreme exponent from a cache 750 as the second input. The cache 750 may be the cache 520 in FIG. 5 or the cache 620 in FIG. 6. The subtractor 730 may be a digital circuit that performs subtraction operation. For instance, the subtractor 730 subtracts the exponent 705S from the extreme exponent and outputs a difference between the exponent 705S and the extreme exponent. The output of the subtractor 730 is a shifting factor and is transmitted to the shifter 740. The shifter 740 is configured to perform bit shift operations. The shifter 740 may be a digital circuit. The shifter 740 receives the shifting factor as a first input and receives the mantissa 705M as the second input from the cache 710. The shifter 740 can perform a right shift of the value of the shifting factor on the mantissa 705M. The shifter 740 outputs a fixed-point value, which is converted from the floating-point value based on the extreme exponent by the conversion module 700.

The output of the shifter 740 (i.e., the fixed-point value) is provided to the PE array 720. The PE array 720, which also receives the sign bit 705S, can perform a signed multiplication operation on the fixed-point value. For instance, the PE array 720 can multiply the signed fixed-point value with another signed fixed-point value and determine a fixed-pointed product. The other signed fixed-point value may be an output of the conversion module 700 or of another conversion module associated with the PE array 720.

FIG. 8 illustrates an inverse transformation module 800, in accordance with various embodiments. The inverse transformation module 800 may be an embodiment of the inverse transformation module 240 in FIG. 2. In the embodiments of FIG. 8, the inverse transformation module 800 includes a reversion module 810, an adder 820, and a floating-point accumulator 830. In other embodiments, the inverse transformation module 800 may include fewer, more, or different components. For instance, the floating-point accumulator 830 may be external to the inverse transformation module 800. The inverse transformation module 800 is at least partially implemented in hardware.

The reversion module 810 converts a fixed-point value to a floating-point value. The reversion module 810 may be an embodiment of the reversion module 280 in FIG. 2. In FIG. 8, the reversion module 810 receives an integer inner product 815. The inner product 815 is a fixed-point value and is a result of a multiplication of two vectors: e.g., a row in a fixed-point matrix and a column in another fixed-point matrix. The reversion module 810 outputs a floating-point value 825, which includes an exponent 825S and a mantissa 825M. The floating-point value 825 may also include a sign, which is not shown in FIG. 8. The exponent 825S is transmitted to the adder 820. The adder 820 also receives a row exponent 835, which is an extreme exponent of the row, and a column exponent 845, which is an extreme exponent of the column. The adder 820 performs an addition operation on the exponent 825S, row exponent 835 and column exponent 845, which generates a new exponent 827S. The new exponent 827S and the mantissa 825E constitute a new floating-point value, which is a scaled floating-point variant of the inner product 815.

The new floating-point value may be formed by the floating-point accumulator 830. The floating-point accumulator 830 may also receive another floating-point value 855 that includes an exponent 855S and a mantissa 855M. The floating-point value 855 may be converted from a fixed-point value of the reversion module 810 and adder 820, or different components. The floating-point accumulator 830 may accumulate the new floating-point value including the exponent 827S and the mantissa 825E with the floating-point value 855, the result of which is an accumulated floating-point value.

### Example PE Array

FIG. 9 illustrates a PE array 900, in accordance with various embodiments. The PE array 900 is an embodiment of the PE array 220 in FIG. 2. The PE array 900 includes a plurality of PEs 910 (individually referred to as “PE 910”). The PEs 910 perform MAC operations. The PEs 910 may also be referred to as neurons in the DNN. Each PE 910 has two input signals 950 and 960 and an output signal 970. The input signal 950, e.g., is a portion of the input (e.g., a portion of an IFM) to the layer. The input signal 960 is a portion of the weights of the layer. The weights can have non-zero values and zero values. The values of the weights are determined during the process of training the DNN. The weights can be divided and assigned to the PEs based on bitmaps. In some embodiments, the input signal 950 of a PE 910 is an input operand, and the input signal 960 is a weight operand.

Each PE 910 performs an MAC operation on the input signals 950 and 960 and outputs the output signal 970, which is a result of the MAC operation. Some or all of the input signals 950 and 960 and the output signal 970 may be in a floating-point format, such as FP16 or BF16, or in an integer format, such as INT8. For purpose of simplicity and illustration, the input signals and output signal of all the PEs 910 have the same reference numbers, but the PEs 910 may receive different input signals and output different output signals from each other. Also, a PE 910 may be different from another PE 910, e.g., include different register files, different MAC units, etc.

As shown in FIG. 9, the PEs 910 are connected to each other, as indicated by the dash arrows in FIG. 9. The output signal 970 of an PE 910 is sent to many other PEs 910 (and possibly back to itself) as input signals via the interconnections between PEs 910. In some embodiments, the output signal 970 of an PE 910 may incorporate the output signals of one or more other PEs 910 through an accumulate operation of the PE 910 and generates an internal partial sum of the PE array. More details about the PEs 910 are described below in conjunction with FIG. 9B.

In the embodiment of FIG. 9, the PEs 910 are arranged into columns 905 (individually referred to as “column 905”). The input and weights of the layer may be distributed to the PEs 910 based on the columns 905. Each column 905 has a column buffer 920. The column buffer 920 stores data provided to the PEs 910 in the column 905 for a short amount of time. The column buffer 920 may also store data output by the last PE 910 in the column 905. The output of the last PE 910 may be a sum of the MAC operations of all the PEs 910 in the column 905, which is a column-level internal partial sum of the PE array 900. In other embodiments, input and weights may be distributed to the PEs 910 based on rows in the PE array 900. The PE array 900 may include row buffers in lieu of column buffers 920. A row buffer may store input signals of the PEs in the corresponding row and may also store a row-level internal partial sum of the PE array 900.

As shown in FIG. 9, each column buffer 920 is associated with a load 930 and a drain 940. The data provided to the column 905 is transmitted to the column buffer 920 through the load 930. In some embodiments, the load 930 may be facilitated by the concatenating module 240 in FIG. 1. The data generated by the column 905 is extracted from the column buffers 920 through the drain 940. In some embodiments, data extracted from a column buffer 920 is sent to upper memory hierarchies, e.g., the memory 210 in FIG. 2, through the drain operation. In some embodiments, the drain operation does not start until all the PEs 910 in the column 905 has finished their MAC operations.

FIG. 10 is a block diagram of a PE 910, in accordance with various embodiments. The PE 910 in FIG. 9B includes an input register file 940, a weight register file 950, an output register file 960, and a MAC unit 970. In other embodiments, the PE 910 may include fewer, more, or different components.

The input register file 940 temporarily stores input signals (e.g., contexts) received by the PE 910. The input feature data may include input feature data and output signals from other PEs 910. The weight register file 950 temporarily stores weights received by the PE 910. The output register file 960 temporarily stores output signals generated by the PE 910. For purpose of illustration and simplicity, the PE 910 in FIG. 9B includes one input register file 940, one weight register file 950, one output register file 960. In other embodiments, a PE 910 may include multiple register files for each type of data.

The MAC unit 970 performs MAC operations on data in the input register file 940 and weight register file 950. The MAC unit 970 includes a multiply unit 980 and an accumulate unit 990. The multiply unit 980 performs multiply operations on input feature data in the input register file 940 and weights in the weight register file 950. The amount of time needed by the multiply unit 980 for a multiple operation depends on the sparsity level of the weights used in the multiple operation. If the weights are denser (i.e., the sparsity level is lower), the multiply unit 980 needs more time to perform the multiple operation. The accumulate unit 990 performs accumulate operations on the output of the multiply unit 980 and outputs signals from other PEs. The output of the accumulate unit 990 is the output signal of the PE 910.

### Example Method of Deep Learning

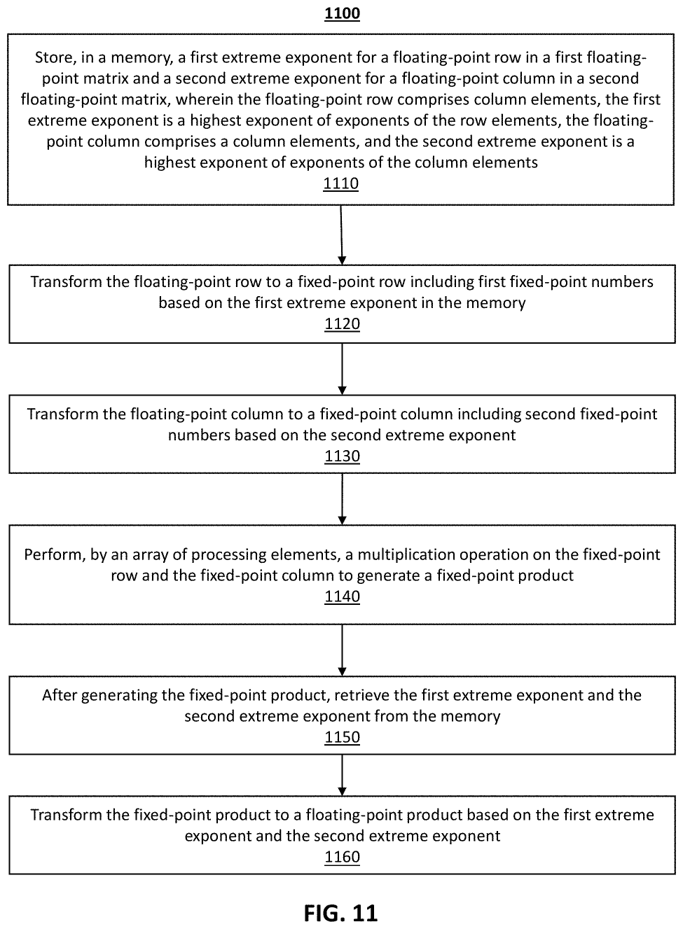

FIG. 11 is a flowchart showing a method 1100 of deep learning, in accordance with various embodiments. The method 1100 may be performed by the DNN accelerator 200 in FIG. 2. Although the method 1100 is described with reference to the flowchart illustrated in FIG. 11, many other methods for depthwise convolution may alternatively be used. For example, the order of execution of the steps in FIG. 11 may be changed. As another example, some of the steps may be changed, eliminated, or combined.

The DNN accelerator 200 stores 1110, in a memory, a first extreme exponent for a floating-point row in a first floating-point matrix and a second extreme exponent for a floating-point column in a second floating-point matrix. The row comprises row elements. The first extreme exponent is a highest exponent of exponents of the row elements. The column comprises column elements, and the second extreme exponent is a highest exponent of exponents of the column elements.

In some embodiments, the row elements are stored as a cache line. The DNN accelerator 200 may retrieve a first extreme exponent from the memory. The DNN accelerator 200 may also input the first extreme exponent and an exponent of a first row element in the cache line into a digital circuit. The digital circuit determines a second extreme exponent. The second extreme is a higher exponent of the first extreme exponent and the exponent of the first row element. The DNN accelerator 200 may also input the second extreme exponent and an exponent of a second row element in the cache line into the digital circuit. The digital circuit determining a third extreme exponent. The third extreme exponent is a higher exponent of the second extreme exponent and the exponent of the second row element. The DNN accelerator 200 stores the third extreme exponent in the memory.

The DNN accelerator 200 may input the column elements in the column into a group of digital circuits, each digital circuit receiving a different column element in the column and selecting a higher exponent of an exponent stored in the memory and an exponent of the different column element. Then the DNN accelerator 200 may store the higher exponent in the memory.

The DNN accelerator 200 transforms 1120 the floating-point row to a fixed-point row including first fixed-point numbers based on the first extreme exponent in the memory. In some embodiments, for each respective row element in the floating-point row, the DNN accelerator 200 may determine a shifting factor by inputting the first extreme exponent and an exponent of the respective row element into a first digital circuit. The first digital circuit outputs a difference between the first extreme exponent and the exponent of the respective row element. The DNN accelerator 200 may transforms the respective row element to one of the first fixed-point numbers by inputting the respective row element and shifting factor into a second digital circuit. The second digital circuit performs right shifts on mantissa bits of the respective row element based on the shifting factor.

The DNN accelerator 200 transforms 1130 the floating-point column to a fixed-point column including second fixed-point numbers based on the second extreme exponent. In some embodiments, for each respective column element in the floating-point column, the DNN accelerator 200 may determine a shifting factor by inputting the second extreme exponent and an exponent of the respective column element into a first digital circuit. The first digital circuit outputs a difference between the second extreme exponent and the exponent of the respective column element. The DNN accelerator 200 may transform the respective column element to one of the second fixed-point numbers by inputting the respective column element and shifting factor into a second digital circuit. The second digital circuit performs right shifts on mantissa bits of the respective column element based on the shifting factor.

The DNN accelerator 200 performs 1140, by an array of PEs, a multiplication operation on the fixed-point row and the fixed-point column to generate a fixed-point product. The array of PEs may be the PE array 220 in FIG. 2, the PE array 720 in FIG. 7, or the PE array 900 in FIG. 9.

After generating the fixed-point product, the DNN accelerator 200 retrieves 1150 the first extreme exponent and the second extreme exponent from the memory. The DNN accelerator 200 transforms 1160 the fixed-point product to a floating-point product based on the first extreme exponent and the second extreme exponent. In some embodiments, the DNN accelerator 200 scales the fixed-point product by a scaling factor to generate a new fixed-point product. The scaling factor equals a sum of the first extreme exponent and the second extreme exponent. The DNN accelerator 200 further transforms the new fixed-point product to the floating-point product. In other embodiments, the DNN accelerator 200 transforms the fixed-point product to an intermediate floating-point product. Then the DNN accelerator 200 scales the intermediate floating-point product based on the first extreme exponent and the second extreme exponent.

The floating-point product may be referred to as a floating-point inner product. The floating-point product may be an element of a product floating-point matrix that is the result of the multiplication operation on the first floating-point matrix and the second floating-point matrix. The product floating-point matrix may include other elements that can be determined by the DNN accelerator 200 using a method that is similar to the method 1100. In some embodiments, the floating-point product may be accumulated with an additional floating-point product. The additional floating-point product is a result of multiplying a row in a third floating-point matrix with a column of a fourth floating-point matrix.

In some embodiments, the memory, digital circuits, and array of PEs are components of the DNN accelerator 200. For instance, the floating-point row is transformed to the fixed-point row by a first digital circuit, and the fixed-point product is transformed to the floating-point product a second digital circuit. The first digital circuit and the second digital circuit are arranged outside the array of processing elements. The memory may be local to the array of PEs. In some embodiments, the memory is a cache associated with the array of processing elements, such as the cache 520, 620, or 750.

### Example Deep Learning Environment

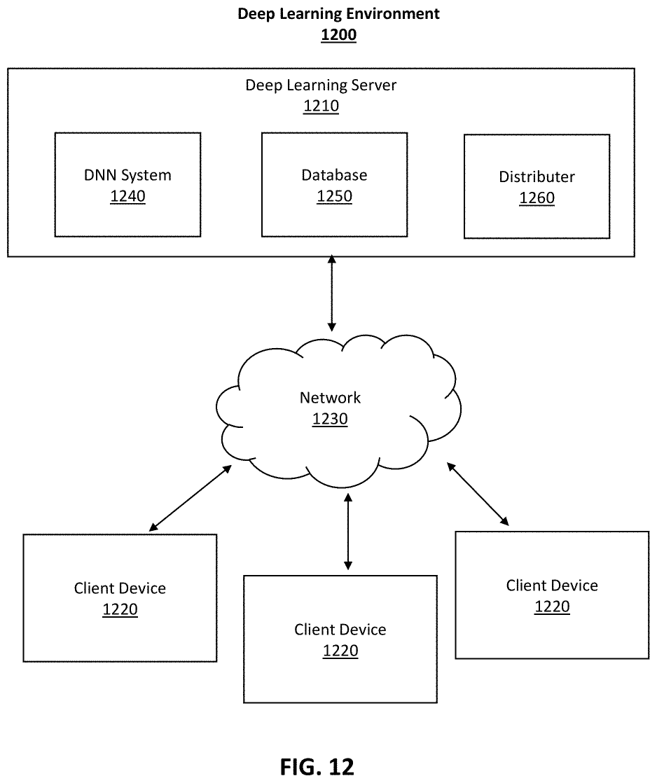

FIG. 12 illustrates a deep learning environment 1200, in accordance with various embodiments. The deep learning environment 1200 includes a deep learning server 1210 and a plurality of client devices 1220 (individually referred to as client device 1220). The deep learning server 1210 is connected to the client devices 1220 through a network 1230. In other embodiments, the deep learning environment 1200 may include fewer, more, or different components.

The deep learning server 1210 trains deep learning models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The deep learning server 1210 can use various types of neural networks, such as DNN, recurrent neural network (RNN), generative adversarial network (GAN), long short-term memory network (LSTMN), and so on. During the process of training the deep learning models, the neural networks use unknown elements in the input distribution to extract features, group objects, and discover useful data patterns. The deep learning models can be used to solve various problems, e.g., making predictions, classifying images, and so on. The deep learning server 1210 may build Deep learning models specific to particular types of problems that need to be solved. A deep learning model is trained to receive an input and outputs the solution to the particular problem.

In FIG. 12, the deep learning server 1210 includes a DNN system 1240, a database 1250, and a distributer 1260. The DNN system 1240 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 120 described above in conjunction with FIG. 1. In some embodiments, the DNN system 1240 trains DNNs through knowledge distillation, e.g., dense-connection based knowledge distillation. The trained DNNs may be used on low memory systems, like mobile phones, IOT edge devices, and so on. An embodiment of the DNN system 1240 is the DNN accelerator 200 described above in conjunction with FIG. 2.

The database 1250 stores data received, used, generated, or otherwise associated with the deep learning server 1210. For example, the database 1250 stores a training dataset that the DNN system 1240 uses to train DNNs. In an embodiment, the training dataset is an image gallery that can be used to train a DNN for classifying images. The training dataset may include data received from the client devices 1220. As another example, the database 1250 stores hyperparameters of the neural networks built by the deep learning server 1210.

The distributer 1260 distributes deep learning models generated by the deep learning server 1210 to the client devices 1220. In some embodiments, the distributer 1260 receives a request for a DNN from a client device 1220 through the network 1230. The request may include a description of a problem that the client device 1220 needs to solve. The request may also include information of the client device 1220, such as information describing available computing resource on the client device. The information describing available computing resource on the client device 1220 can be information indicating network bandwidth, information indicating available memory size, information indicating processing power of the client device 1220, and so on. In an embodiment, the distributer may instruct the DNN system 1240 to generate a DNN in accordance with the request. The DNN system 1240 may generate a DNN based on the information in the request. For instance, the DNN system 1240 can determine the structure of the DNN and/or train the DNN in accordance with the request.

In another embodiment, the distributer 1260 may select the DNN from a group of pre-existing DNNs based on the request. The distributer 1260 may select a DNN for a particular client device 1230 based on the size of the DNN and available resources of the client device 1220. In embodiments where the distributer 1260 determines that the client device 1220 has limited memory or processing power, the distributer 1260 may select a compressed DNN for the client device 1220, as opposed to an uncompressed DNN that has a larger size. The distributer 1260 then transmits the DNN generated or selected for the client device 1220 to the client device 1220.

In some embodiments, the distributer 1260 may receive feedback from the client device 1220. For example, the distributer 1260 receives new training data from the client device 1220 and may send the new training data to the DNN system 1240 for further training the DNN. As another example, the feedback includes an update of the available computer resource on the client device 1220. The distributer 1260 may send a different DNN to the client device 1220 based on the update. For instance, after receiving the feedback indicating that the computing resources of the client device 1220 have been reduced, the distributer 1260 sends a DNN of a smaller size to the client device 1220.

The client devices 1220 receive DNNs from the distributer 1260 and applies the DNNs to perform machine learning tasks, e.g., to solve problems or answer questions. In various embodiments, the client devices 1220 input images into the DNNs and uses the output of the DNNs for various applications, e.g., visual reconstruction, augmented reality, robot localization and navigation, medical diagnosis, weather prediction, and so on. A client device 1220 may be one or more computing devices capable of receiving user input as well as transmitting and/or receiving data via the network 1230. In one embodiment, a client device 1220 is a conventional computer system, such as a desktop or a laptop computer. Alternatively, a client device 1220 may be a device having computer functionality, such as a personal digital assistant (PDA), a mobile telephone, a smartphone, an autonomous vehicle, or another suitable device. A client device 1220 is configured to communicate via the network 1230. In one embodiment, a client device 1220 executes an application allowing a user of the client device 1220 to interact with the deep learning server 1210 (e.g., the distributer 1260 of the deep learning server 1210). The client device 1220 may request DNNs or send feedback to the distributer 1260 through the application. For example, a client device 1220 executes a browser application to enable interaction between the client device 1220 and the deep learning server 1210 via the network 1230. In another embodiment, a client device 1220 interacts with the deep learning server 1210 through an application programming interface (API) running on a native operating system of the client device 1220, such as IOS® or ANDROID™.

In an embodiment, a client device 1220 is an integrated computing device that operates as a standalone network-enabled device. For example, the client device 1220 includes display, speakers, microphone, camera, and input device. In another embodiment, a client device 1220 is a computing device for coupling to an external media device such as a television or other external display and/or audio output system. In this embodiment, the client device 1220 may couple to the external media device via a wireless interface or wired interface (e.g., an HDMI (High-Definition Multimedia Interface) cable) and may utilize various functions of the external media device such as its display, speakers, microphone, camera, and input devices. Here, the client device 1220 may be configured to be compatible with a generic external media device that does not have specialized software, firmware, or hardware specifically for interacting with the client device 1220.

The network 1230 supports communications between the deep learning server 1210 and client devices 1220. The network 1230 may comprise any combination of local area and/or wide area networks, using both wired and/or wireless communication systems. In one embodiment, the network 1230 may use standard communications technologies and/or protocols. For example, the network 1230 may include communication links using technologies such as Ethernet, 12010.11, worldwide interoperability for microwave access (WiMAX), 3G, 4G, code division multiple access (CDMA), digital subscriber line (DSL), etc. Examples of networking protocols used for communicating via the network 1230 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1230 may be represented using any suitable format, such as hypertext markup language (HTML) or extensible markup language (XML). In some embodiments, all or some of the communication links of the network 1230 may be encrypted using any suitable technique or techniques.

### Example DNN System

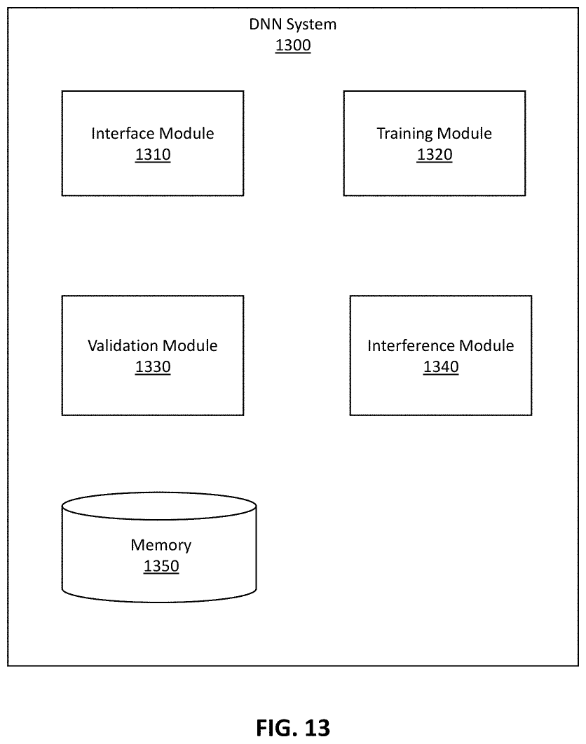

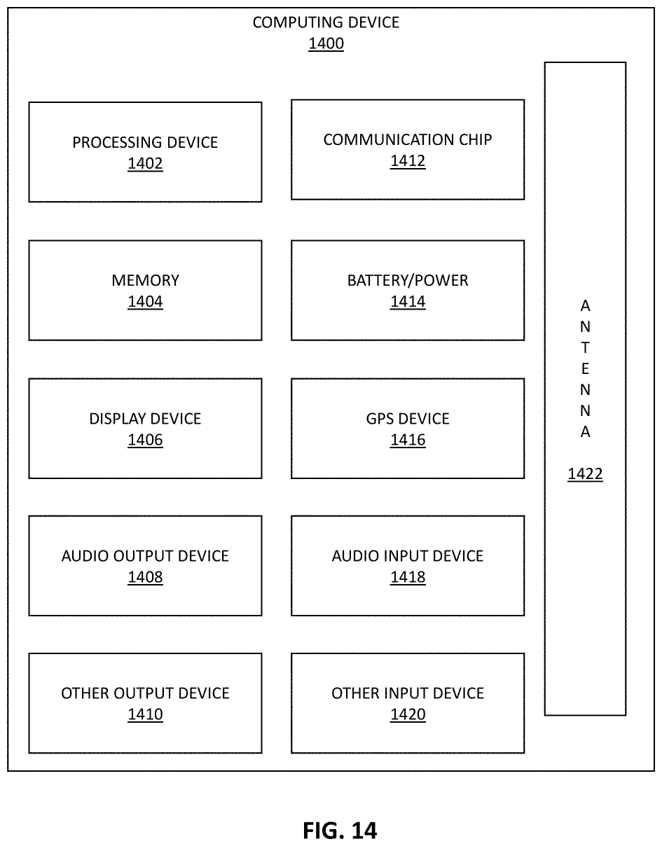

FIG. 13 is a block diagram of an example DNN system 1300, in accordance with various embodiments. The whole DNN system 1300 or a part of the DNN system 1300 may be implemented in the computing device 1400 in FIG. 14. The DNN system 1300 trains DNNs for various tasks, such as image classification, learning relationships between biological cells (e.g., DNA, proteins, etc.), control behaviors for devices (e.g., robots, machines, etc.), and so on. The DNN system 1300 includes an interface module 1310, a training module 1320, a validation module 1330, an inference module 1340, and a memory 1350. In other embodiments, alternative configurations, different or additional components may be included in the DNN system 1300. Further, functionality attributed to a component of the DNN system 1300 may be accomplished by a different component included in the DNN system 1300 or a different system. The DNN system 1300 or a component of the DNN system 1300 (e.g., the training module 1320 or inference module 1340) may include the computing device 1400.

The interface module 1310 facilitates communications of the DNN system 1300 with other systems. For example, the interface module 1310 establishes communications between the DNN system 1300 with an external database to receive data that can be used to train DNNs or input into DNNs to perform tasks. As another example, the interface module 1310 supports the DNN system 1300 to distribute DNNs to other systems, e.g., computing devices configured to apply DNNs to perform tasks.

The training module 1320 trains DNNs by using a training dataset. The training module 1320 forms the training dataset. In an embodiment where the training module 1320 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 1330 to validate performance of a trained DNN. The portion of the training dataset not including the tuning subset and the validation subset may be used to train the DNN.

The training module 1320 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 13, 130, 500, 1300, or even larger.

The training module 1320 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 1320 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 1320 defines the architecture of the DNN, the training module 1320 inputs a training dataset into the DNN. The training dataset includes a plurality of training samples. An example of a training sample includes an object in an image and a ground-truth label of the object. The training module 1320 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 1320 uses a cost function to minimize the error.

The training module 1320 may train the DNN for a predetermined number of epochs. The number of epochs is a hyperparameter that defines the number of times that the DL algorithm will work through the entire training dataset. One epoch means that each sample in the training dataset has had an opportunity to update internal parameters of the DNN. After the training module 1320 finishes the predetermined number of epochs, the training module 1320 may stop updating the parameters in the DNN. The DNN having the updated parameters is referred to as a trained DNN.

The validation module 1330 verifies accuracy of trained DNNs. In some embodiments, the validation module 1330 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1330 determines may determine an accuracy score measuring the precision, recall, or a combination of precision and recall of the DNN. The validation module 1330 may use the following metrics to determine the accuracy score: Precision =TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 1330 may compare the accuracy score with a threshold score. In an example where the validation module 1330 determines that the accuracy score of the augmented model is lower than the threshold score, the validation module 1330 instructs the training module 1320 to re-train the DNN. In one embodiment, the training module 1320 may iteratively re-train the DNN until the occurrence of a stopping condition, such as the accuracy measurement indication that the DNN may be sufficiently accurate, or a number of training rounds having taken place.

The inference module 1340 applies the trained or validated DNN to perform tasks. For instance, the inference module 1340 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 1340 distributes the DNN to other systems, e.g., computing devices in communication with the DNN system 1300, for the other systems to apply the DNN to perform the tasks.

The memory 1350 stores data received, generated, used, or otherwise associated with the DNN system 1300. For example, the memory 1350 stores the datasets used by the training module 1320 and validation module 1330. The memory 1350 may also store data generated by the training module 1320 and validation module 1330, such as the hyperparameters for training DNNs, internal parameters of trained DNNs (e.g., values of tunable parameters of FALUs), etc. In the embodiment of FIG. 13, the memory 1350 is a component of the DNN system 1300. In other embodiments, the memory 1350 may be external to the DNN system 1300 and communicate with the DNN system 1300 through a network.

### Example Computing Device

FIG. 14 is a block diagram of an example computing device 1400, in accordance with various embodiments. In some embodiments, the computing device 1400 can be used as the DNN system 1100 in FIG. 11. A number of components are illustrated in FIG. 14 as included in the computing device 1400, but any one or more of these components may be omitted or duplicated, as suitable for the application. In some embodiments, some or all of the components included in the computing device 1400 may be attached to one or more motherboards. In some embodiments, some or all of these components are fabricated onto a single system on a chip (SoC) die. Additionally, in various embodiments, the computing device 1400 may not include one or more of the components illustrated in FIG. 14, but the computing device 1400 may include interface circuitry for coupling to the one or more components. For example, the computing device 1400 may not include a display device 1406, but may include display device interface circuitry (e.g., a connector and driver circuitry) to which a display device 1406 may be coupled. In another set of examples, the computing device 1400 may not include an audio input device 1418 or an audio output device 1408, but may include audio input or output device interface circuitry (e.g., connectors and supporting circuitry) to which an audio input device 1418 or audio output device 1408 may be coupled.

The computing device 1400 may include a processing device 1402 (e.g., one or more processing devices). The processing device 1402 processes electronic data from registers and/or memory to transform that electronic data into other electronic data that may be stored in registers and/or memory. An embodiment of the processing device 1402 may be the processor 260 in FIG. 2. The computing device 1400 may include a memory 1404, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1404 may include memory that shares a die with the processing device 1402. In some embodiments, the memory 1404 includes one or more non-transitory computer-readable media storing instructions executable to perform operations for deep learning, e.g., the method 1100 described above in conjunction with FIG. 11 or some operations performed by the DNN accelerator 200 described above in conjunction with FIG. 2. The instructions stored in the one or more non-transitory computer-readable media may be executed by the processing device 1402.

In some embodiments, the computing device 1400 may include a communication chip 1412 (e.g., one or more communication chips). For example, the communication chip 1412 may be configured for managing wireless communications for the transfer of data to and from the computing device 1400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1412 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1412 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1412 may operate in accordance with other wireless protocols in other embodiments. The computing device 1400 may include an antenna 1422 to facilitate wireless communications and/or to receive other wireless communications (such as AM or FM radio transmissions).

In some embodiments, the communication chip 1412 may manage wired communications, such as electrical, optical, or any other suitable communication protocols (e.g., the Ethernet). As noted above, the communication chip 1412 may include multiple communication chips. For instance, a first communication chip 1412 may be dedicated to shorter-range wireless communications such as Wi-Fi or Bluetooth, and a second communication chip 1412 may be dedicated to longer-range wireless communications such as global positioning system (GPS), EDGE, GPRS, CDMA, WiMAX, LTE, EV-DO, or others. In some embodiments, a first communication chip 1412 may be dedicated to wireless communications, and a second communication chip 1412 may be dedicated to wired communications.

The computing device 1400 may include battery/power circuitry 1414. The battery/power circuitry 1414 may include one or more energy storage devices (e.g., batteries or capacitors) and/or circuitry for coupling components of the computing device 1400 to an energy source separate from the computing device 1400 (e.g., AC line power).

The computing device 1400 may include a display device 1406 (or corresponding interface circuitry, as discussed above). The display device 1406 may include any visual indicators, such as a heads-up display, a computer monitor, a projector, a touchscreen display, a liquid crystal display (LCD), a light-emitting diode display, or a flat panel display, for example.

The computing device 1400 may include an audio output device 1408 (or corresponding interface circuitry, as discussed above). The audio output device 1408 may include any device that generates an audible indicator, such as speakers, headsets, or earbuds, for example.

The computing device 1400 may include an audio input device 1418 (or corresponding interface circuitry, as discussed above). The audio input device 1418 may include any device that generates a signal representative of a sound, such as microphones, microphone arrays, or digital instruments (e.g., instruments having a musical instrument digital interface (MIDI) output).

The computing device 1400 may include a GPS device 1416 (or corresponding interface circuitry, as discussed above). The GPS device 1416 may be in communication with a satellite-based system and may receive a location of the computing device 1400, as known in the art.

The computing device 1400 may include an other output device 1410 (or corresponding interface circuitry, as discussed above). Examples of the other output device 1410 may include an audio codec, a video codec, a printer, a wired or wireless transmitter for providing information to other devices, or an additional storage device.

The computing device 1400 may include an other input device 1420 (or corresponding interface circuitry, as discussed above). Examples of the other input device 1420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (register fileID) reader.

The computing device 1400 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1400 may be any other electronic device that processes data.

### Select Examples

The following paragraphs provide various examples of the embodiments disclosed herein.

Example 1 provides a method for deep learning, the method including storing, in a memory, the first extreme exponent for a floating-point row in a first floating-point matrix and the second extreme exponent for a floating-point column in a second floating-point matrix, where the row includes row elements, the first extreme exponent is a highest exponent of exponents of the row elements, the column includes column elements, and the second extreme exponent is a highest exponent of exponents of the column elements; transforming the floating-point row to a fixed-point row including first fixed-point numbers based on the first extreme exponent in the memory; transforming the floating-point column to a fixed-point column including second fixed-point numbers based on the second extreme exponent; performing, by an array of processing elements, a multiplication operation on the fixed-point row and the fixed-point column to generate a fixed-point product; after generating the fixed-point product, retrieving the first extreme exponent and the second extreme exponent from the memory; and transforming the fixed-point product to a floating-point product based on the first extreme exponent and the second extreme exponent.

Example 2 provides the method of example 1, where the row elements are stored as a cache line, and the method further includes retrieving a first extreme exponent from the memory; inputting the first extreme exponent and an exponent of a first row element in the cache line into a digital circuit, the digital circuit determining a second extreme exponent, where the second extreme is a higher exponent of the first extreme exponent and the exponent of the first row element; inputting the second extreme exponent and an exponent of a second row element in the cache line into a digital circuit, the digital circuit determining a third extreme exponent, where the third extreme exponent is a higher exponent of the second extreme exponent and the exponent of the second row element; and storing the third extreme exponent in the memory.

Example 3 provides the method of example 1 or 2, further including inputting the column elements in the column into a group of digital circuits, each digital circuit receiving a different column element in the column and selecting a higher exponent of an exponent stored in the memory and an exponent of the different column element; and storing the higher exponent in the memory.

Example 4 provides the method of any of the preceding examples, where transforming the floating-point row to the fixed-point row including the first fixed-point numbers based on the first extreme exponent in the memory includes for each respective row element in the floating-point row: determining a shifting factor by inputting the first extreme exponent and an exponent of the respective row element into a first digital circuit, the first digital circuit outputting a difference between the first extreme exponent and the exponent of the respective row element; and transforming the respective row element to one of the first fixed-point numbers by inputting the respective row element and shifting factor into a second digital circuit, the second digital circuit performing right shifts on mantissa bits of the respective row element based on the shifting factor.

Example 5 provides the method of any of the preceding examples, where transforming the floating-point column to the fixed-point column including the second fixed-point numbers based on the second extreme exponent includes for each respective column element in the floating-point column: determining a shifting factor by inputting the second extreme exponent and an exponent of the respective column element into a first digital circuit, the first digital circuit outputting a difference between the second extreme exponent and the exponent of the respective column element; and transforming the respective column element to one of the second fixed-point numbers by inputting the respective column element and shifting factor into a second digital circuit, the second digital circuit performing right shifts on mantissa bits of the respective column element based on the shifting factor.

Example 6 provides the method of any of the preceding examples, where transforming the fixed-point product to a floating-point product based on the first extreme exponent and the second extreme exponent includes scaling the fixed-point product by a scaling factor to generate a new fixed-point product, the scaling factor equal a sum of the first extreme exponent and the second extreme exponent; and transforming the new fixed-point product to the floating-point product.

Example 7 provides the method of any of the preceding examples, where transforming the fixed-point product to a floating-point product based on the first extreme exponent and the second extreme exponent includes transforming the fixed-point product to an intermediate floating-point product; and scaling the intermediate floating-point product based on the first extreme exponent and the second extreme exponent.

Example 8 provides the method of any of the preceding examples, where the floating-point row is transformed to the fixed-point row by a first digital circuit, the fixed-point product is transformed to the floating-point product a second digital circuit, and the first digital circuit and the second digital circuit are arranged outside the array of processing elements.

Example 9 provides the method of any of the preceding examples, where the memory is a cache associated with the array of processing elements.

Example 10 provides the method of any of the preceding examples, further including accumulating the floating-point product with an additional floating-point product, where the additional floating-point product is a result of multiplying a row in a third floating-point matrix with a column of a fourth floating-point matrix.

Example 11 provides one or more non-transitory computer-readable media storing instructions executable to perform operations for deep learning, the operations including storing, in a memory, the first extreme exponent for a floating-point row in a first floating-point matrix and the second extreme exponent for a floating-point column in a second floating-point matrix, where the row includes row elements, the first extreme exponent is a highest exponent of exponents of the row elements, the column includes column elements, and the second extreme exponent is a highest exponent of exponents of the column elements; transforming the floating-point row to a fixed-point row including first fixed-point numbers based on the first extreme exponent in the memory; transforming the floating-point column to a fixed-point column including second fixed-point numbers based on the second extreme exponent; performing, by an array of processing elements, a multiplication operation on the fixed-point row and the fixed-point column to generate a fixed-point product; after generating the fixed-point product, retrieving the first extreme exponent and the second extreme exponent from the memory; and transforming the fixed-point product to a floating-point product based on the first extreme exponent and the second extreme exponent.

Example 12 provides the one or more non-transitory computer-readable media of example 11, where the row elements are stored as a cache line, and the method further includes retrieving a first extreme exponent from the memory; inputting the first extreme exponent and an exponent of a first row element in the cache line into a digital circuit, the digital circuit determining a second extreme exponent, where the second extreme is a higher exponent of the first extreme exponent and the exponent of the first row element; inputting the second extreme exponent and an exponent of a second row element in the cache line into a digital circuit, the digital circuit determining a third extreme exponent, where the third extreme exponent is a higher exponent of the second extreme exponent and the exponent of the second row element; and storing the third extreme exponent in the memory.

Example 13 provides the one or more non-transitory computer-readable media of example 11 or 12, where operations further include inputting the column elements in the column into a group of digital circuits, each digital circuit receiving a different column element in the column and selecting a higher exponent of an exponent stored in the memory and an exponent of the different column element; and storing the higher exponent in the memory.

Example 14 provides the one or more non-transitory computer-readable media of any one of examples 11-13, where transforming the floating-point row to the fixed-point row including the first fixed-point numbers based on the first extreme exponent in the memory includes for each respective row element in the floating-point row: determining a shifting factor by inputting the first extreme exponent and an exponent of the respective row element into a first digital circuit, the first digital circuit outputting a difference between the first extreme exponent and the exponent of the respective row element; and transforming the respective row element to one of the first fixed-point numbers by inputting the respective row element and shifting factor into a second digital circuit, the second digital circuit performing right shifts on mantissa bits of the respective row element based on the shifting factor.

Example 15 provides the one or more non-transitory computer-readable media of any one of examples 11-14, where transforming the floating-point column to the fixed-point column including the second fixed-point numbers based on the second extreme exponent includes: for each respective column element in the floating-point column: determining a shifting factor by inputting the second extreme exponent and an exponent of the respective column element into a first digital circuit, the first digital circuit outputting a difference between the second extreme exponent and the exponent of the respective column element; and transforming the respective column element to one of the second fixed-point numbers by inputting the respective column element and shifting factor into a second digital circuit, the second digital circuit performing right shifts on mantissa bits of the respective column element based on the shifting factor.

Example 16 provides the one or more non-transitory computer-readable media of any one of examples 11-15, where transforming the fixed-point product to a floating-point product based on the first extreme exponent and the second extreme exponent includes scaling the fixed-point product by a scaling factor to generate a new fixed-point product, the scaling factor equal a sum of the first extreme exponent and the second extreme exponent; and transforming the new fixed-point product to the floating-point product.

Example 17 provides the one or more non-transitory computer-readable media of any one of examples 11-16, where transforming the fixed-point product to a floating-point product based on the first extreme exponent and the second extreme exponent includes transforming the fixed-point product to an intermediate floating-point product; and scaling the intermediate floating-point product based on the first extreme exponent and the second extreme exponent.

Example 18 provides the one or more non-transitory computer-readable media of any one of examples 11-17, where the floating-point row is transformed to the fixed-point row by a first digital circuit, the fixed-point product is transformed to the floating-point product a second digital circuit, and the first digital circuit and the second digital circuit are arranged outside the array of processing elements.

Example 19 provides the one or more non-transitory computer-readable media of any one of examples 11-18, where the memory is a cache associated with the array of processing elements.

Example 20 provides the one or more non-transitory computer-readable media of any one of examples 11-19, where the operations further include accumulating the floating-point product with an additional floating-point product, where the additional floating-point product is a result of multiplying a row in a third floating-point matrix with a column of a fourth floating-point matrix.

Example 21 provides a DNN accelerator, the DNN accelerator including a memory for storing the first extreme exponent for a floating-point row in a first floating-point matrix and the second extreme exponent for a floating-point column in a second floating-point matrix, where the row includes row elements, the first extreme exponent is a highest exponent of exponents of the row elements, the column includes column elements, and the second extreme exponent is a highest exponent of exponents of the column elements; one or more first digital circuits configured to: retrieve the first extreme exponent and the second extreme exponent from the memory, transform the floating-point row to a fixed-point row including first fixed-point numbers based on the first extreme exponent in the memory, and transform the floating-point column to a fixed-point column including second fixed-point numbers based on the second extreme exponent; an array of processing elements configured to: perform a multiplication operation on the fixed-point row and the fixed-point column to generate a fixed-point product; and one or more second digital circuits configured to: after generating the fixed-point product, retrieve the first extreme exponent and the second extreme exponent from the memory, and transforming the fixed-point product to a floating-point product based on the first extreme exponent and the second extreme exponent.

Example 22 provides the DNN accelerator of example 21, where the one or more first digital circuits and the one or more second digital circuits are arranged outside the array of processing elements.

Example 23 provides the DNN accelerator of example 21 or 22, where the memory is a cache associated with the array of processing elements.

Example 24 provides the DNN accelerator of any one of examples 21-23, where the row elements are stored as a cache line, and the DNN accelerator further includes one or more third digital circuits configured to receive a first extreme exponent from the memory; receive an exponent of a first row element; determine a second extreme exponent, where the second extreme is a higher exponent of the first extreme exponent and the exponent of the first row element, and the second extreme exponent is stored in the memory; receive the second extreme exponent from the memory; and determine a third extreme exponent, where the third extreme exponent is a higher exponent of the second extreme exponent and the exponent of the second row element, and the third extreme exponent is stored in the memory.

Example 25 provides the DNN accelerator of any one of examples 21-24, where the DNN accelerator further includes a plurality of third digital circuits, each of which is configured to receive a different one of the column elements in the column; and selecting a higher exponent of an exponent stored in the memory and an exponent of the different one of the column elements, where the higher exponent is stored in the memory.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for deep learning, the method comprising:
storing, in a memory, a first extreme exponent for a floating-point row in a first floating-point matrix and a second extreme exponent for a floating-point column in a second floating-point matrix, wherein the floating-point row comprises row elements, the first extreme exponent is a highest exponent of exponents of the row elements, the floating-point column comprises column elements, and the second extreme exponent is a highest exponent of exponents of the column elements;
transforming the floating-point row to a fixed-point row including first fixed-point numbers based on the first extreme exponent in the memory;
transforming the floating-point column to a fixed-point column including second fixed-point numbers based on the second extreme exponent;
performing, by an array of processing elements, a multiplication operation on the fixed-point row and the fixed-point column to generate a fixed-point product;
after generating the fixed-point product, retrieving the first extreme exponent and the second extreme exponent from the memory; and
transforming the fixed-point product to a floating-point product based on the first extreme exponent and the second extreme exponent.

2. The method of claim 1, wherein the row elements are stored as a cache line, and the method further comprises:
retrieving a first extreme exponent from the memory;
inputting the first extreme exponent and an exponent of a first row element in the cache line into a digital circuit, the digital circuit determining a second extreme exponent, wherein the second extreme is a higher exponent of the first extreme exponent and the exponent of the first row element;
inputting the second extreme exponent and an exponent of a second row element in the cache line into a digital circuit, the digital circuit determining a third extreme exponent, wherein the third extreme exponent is a higher exponent of the second extreme exponent and the exponent of the second row element; and
storing the third extreme exponent in the memory.

3. The method of claim 1, further comprising:
inputting the column elements in the column into a group of digital circuits, each digital circuit receiving a different column element in the column and selecting a higher exponent of an exponent stored in the memory and an exponent of the different column element; and
storing the higher exponent in the memory.

4. The method of claim 1, wherein transforming the floating-point row to the fixed-point row including the first fixed-point numbers based on the first extreme exponent in the memory comprises:
for each respective row element in the floating-point row:
determining a shifting factor by inputting the first extreme exponent and an exponent of the respective row element into a first digital circuit, the first digital circuit outputting a difference between the first extreme exponent and the exponent of the respective row element; and
transforming the respective row element to one of the first fixed-point numbers by inputting the respective row element and shifting factor into a second digital circuit, the second digital circuit performing right shifts on mantissa bits of the respective row element based on the shifting factor.

5. The method of claim 1, wherein transforming the floating-point column to the fixed-point column including the second fixed-point numbers based on the second extreme exponent comprises:
for each respective column element in the floating-point column:
determining a shifting factor by inputting the second extreme exponent and an exponent of the respective column element into a first digital circuit, the first digital circuit outputting a difference between the second extreme exponent and the exponent of the respective column element; and
transforming the respective column element to one of the second fixed-point numbers by inputting the respective column element and shifting factor into a second digital circuit, the second digital circuit performing right shifts on mantissa bits of the respective column element based on the shifting factor.

6. The method of claim 1, wherein transforming the fixed-point product to a floating-point product based on the first extreme exponent and the second extreme exponent comprises:
scaling the fixed-point product by a scaling factor to generate a new fixed-point product, the scaling factor equal a sum of the first extreme exponent and the second extreme exponent; and
transforming the new fixed-point product to the floating-point product.

7. The method of claim 1, wherein transforming the fixed-point product to a floating-point product based on the first extreme exponent and the second extreme exponent comprises:
transforming the fixed-point product to an intermediate floating-point product; and
scaling the intermediate floating-point product based on the first extreme exponent and the second extreme exponent.

8. The method of claim 1, wherein the floating-point row is transformed to the fixed-point row by a first digital circuit, the fixed-point product is transformed to the floating-point product a second digital circuit, and the first digital circuit and the second digital circuit are arranged outside the array of processing elements.

9. The method of claim 1, wherein the memory is a cache associated with the array of processing elements.

10. The method of claim 1, further comprising:
accumulating the floating-point product with an additional floating-point product,
wherein the additional floating-point product is a result of multiplying a row in a third floating-point matrix with a column of a fourth floating-point matrix.

11. One or more non-transitory computer-readable media storing instructions executable to perform operations for deep learning, the operations comprising:
storing, in a memory, a first extreme exponent for a floating-point row in a first floating-point matrix and a second extreme exponent for a floating-point column in a second floating-point matrix, wherein the row comprises row elements, the first extreme exponent is a highest exponent of exponents of the row elements, the column comprises column elements, and the second extreme exponent is a highest exponent of exponents of the column elements;
transforming the floating-point row to a fixed-point row including first fixed-point numbers based on the first extreme exponent in the memory;
transforming the floating-point column to a fixed-point column including second fixed-point numbers based on the second extreme exponent;
performing, by an array of processing elements, a multiplication operation on the fixed-point row and the fixed-point column to generate a fixed-point product;
after generating the fixed-point product, retrieving the first extreme exponent and the second extreme exponent from the memory; and
transforming the fixed-point product to a floating-point product based on the first extreme exponent and the second extreme exponent.

12. The one or more non-transitory computer-readable media of claim 11, wherein the row elements are stored as a cache line, and the operations further comprises:
retrieving a first extreme exponent from the memory;
inputting the first extreme exponent and an exponent of a first row element in the cache line into a digital circuit, the digital circuit determining a second extreme exponent, wherein the second extreme is a higher exponent of the first extreme exponent and the exponent of the first row element;
inputting the second extreme exponent and an exponent of a second row element in the cache line into a digital circuit, the digital circuit determining a third extreme exponent, wherein the third extreme exponent is a higher exponent of the second extreme exponent and the exponent of the second row element; and
storing the third extreme exponent in the memory.

13. The one or more non-transitory computer-readable media of claim 11, wherein operations further comprise:
inputting the column elements in the column into a group of digital circuits, each digital circuit receiving a different column element in the column and selecting a higher exponent of an exponent stored in the memory and an exponent of the different column element; and
storing the higher exponent in the memory.

14. The one or more non-transitory computer-readable media of claim 11, wherein transforming the floating-point row to the fixed-point row including the first fixed-point numbers based on the first extreme exponent in the memory comprises:
for each respective row element in the floating-point row:
determining a shifting factor by inputting the first extreme exponent and an exponent of the respective row element into a first digital circuit, the first digital circuit outputting a difference between the first extreme exponent and the exponent of the respective row element; and
transforming the respective row element to one of the first fixed-point numbers by inputting the respective row element and shifting factor into a second digital circuit, the second digital circuit performing right shifts on mantissa bits of the respective row element based on the shifting factor.

15. The one or more non-transitory computer-readable media of claim 11, wherein transforming the floating-point column to the fixed-point column including the second fixed-point numbers based on the second extreme exponent comprises:
for each respective column element in the floating-point column:
determining a shifting factor by inputting the second extreme exponent and an exponent of the respective column element into a first digital circuit, the first digital circuit outputting a difference between the second extreme exponent and the exponent of the respective column element; and
transforming the respective column element to one of the second fixed-point numbers by inputting the respective column element and shifting factor into a second digital circuit, the second digital circuit performing right shifts on mantissa bits of the respective column element based on the shifting factor.

16. The one or more non-transitory computer-readable media of claim 11, wherein transforming the fixed-point product to a floating-point product based on the first extreme exponent and the second extreme exponent comprises:
scaling the fixed-point product by a scaling factor to generate a new fixed-point product, the scaling factor equal a sum of the first extreme exponent and the second extreme exponent; and
transforming the new fixed-point product to the floating-point product.

17. The one or more non-transitory computer-readable media of claim 11, wherein transforming the fixed-point product to a floating-point product based on the first extreme exponent and the second extreme exponent comprises:
transforming the fixed-point product to an intermediate floating-point product; and
scaling the intermediate floating-point product based on the first extreme exponent and the second extreme exponent.

18. The one or more non-transitory computer-readable media of claim 11, wherein the floating-point row is transformed to the fixed-point row by a first digital circuit, the fixed-point product is transformed to the floating-point product a second digital circuit, and the first digital circuit and the second digital circuit are arranged outside the array of processing elements.

19. The one or more non-transitory computer-readable media of claim 11, wherein the memory is a cache associated with the array of processing elements.

20. The one or more non-transitory computer-readable media of claim 11, wherein the operations further comprise:
accumulating the floating-point product with an additional floating-point product,
wherein the additional floating-point product is a result of multiplying a row in a third floating-point matrix with a column of a fourth floating-point matrix.

21. A deep neural network (DNN) accelerator, the DNN accelerator comprising:
a memory for storing a first extreme exponent for a floating-point row in a first floating-point matrix and a second extreme exponent for a floating-point column in a second floating-point matrix, wherein the row comprises row elements, the first extreme exponent is a highest exponent of exponents of the row elements, the column comprises column elements, and the second extreme exponent is a highest exponent of exponents of the column elements;
one or more first digital circuits configured to:
retrieve the first extreme exponent and the second extreme exponent from the memory,
transform the floating-point row to a fixed-point row including first fixed-point numbers based on the first extreme exponent in the memory, and
transform the floating-point column to a fixed-point column including second fixed-point numbers based on the second extreme exponent;
an array of processing elements configured to:
perform a multiplication operation on the fixed-point row and the fixed-point column to generate a fixed-point product; and
one or more second digital circuits configured to:
after generating the fixed-point product, retrieve the first extreme exponent and the second extreme exponent from the memory, and
transforming the fixed-point product to a floating-point product based on the first extreme exponent and the second extreme exponent.

22. The DNN accelerator of claim 21, wherein the one or more first digital circuits and the one or more second digital circuits are arranged outside the array of processing elements.

23. The DNN accelerator of claim 21, wherein the memory is a cache associated with the array of processing elements.

24. The DNN accelerator of claim 21, wherein the row elements are stored as a cache line, and the DNN accelerator further comprises one or more third digital circuits configured to:
receive a first extreme exponent from the memory;
receive an exponent of a first row element;
determine a second extreme exponent, wherein the second extreme is a higher exponent of the first extreme exponent and the exponent of the first row element, and the second extreme exponent is stored in the memory;
receive the second extreme exponent from the memory; and
determine a third extreme exponent, wherein the third extreme exponent is a higher exponent of the second extreme exponent and the exponent of the second row element, and the third extreme exponent is stored in the memory.

25. The DNN accelerator of claim 21, wherein the DNN accelerator further comprises a plurality of third digital circuits, each of which is configured to:
receive a different one of the column elements in the column; and
selecting a higher exponent of an exponent stored in the memory and an exponent of the different one of the column elements,
wherein the higher exponent is stored in the memory.
